(19) United States
(12) Patent Application Publication
(10) Pub. No.: US 2020/0288795 A1
(43) Pub. Date: Sep. 17, 2020

(54) FILTERING MASK WITH ANTI-COUNTERFEIT FUNCTION

(71) Applicant: HONEYWELL INTERNATIONAL INC., Morris Plains, NJ (US)

(72) Inventors: Hong Bing XIANG, Morris Plains, NJ (US); Weifeng SHEN, Morris Plains, NJ (US); Yuzheng LU, Morris Plains, NJ (US); Chuang MA, Morris Plains, NJ (US)

(21) Appl. No.: 16/768,106

(22) PCT Filed: Nov. 30, 2017
(86) PCT No.: PCT/CN2017/113803

§ 371 Date: May 29, 2020

(51) Int. Cl. A41D 27/08; A41D 31/14; A41D 13/11; A41H 43/00; A62B 23/02

(52) U.S. Cl. CPC A41D 27/08; A41D 31/145; A62B 23/025; A41D 13/1161; A41H 43/00; A41D 13/11

(57) ABSTRACT

Embodiments relate generally to systems and methods for providing an anti-counterfeit element within a filtering mask. A method of manufacturing a filtering mask may comprise extruding a filtering material from a source of the filtering material; melt-blowing the extruded filtering material to form a plurality of fibers; collecting the melt-blown fibers onto an outer surface of a lathe, wherein the outer surface of the lathe comprises a logo pattern; forming a fiber material about the logo pattern on the outer surface of the lathe via the collected melt-blown fibers; removing the formed fiber material to create an anti-counterfeit layer for use in the filtering mask, wherein at least one surface of the anti-counterfeit layer comprises the logo pattern within the fiber material; and assembling the anti-counterfeit layer within the filtering mask.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Dust masks, and other face masks, may be worn in various situations, such as in city environments where the ambient air could be dangerous to the user, or work environments, where the user may be exposed to dangerous particles in the air. Masks may be worn over the user's nose and mouth to ensure that the user does not inhale hazardous materials. In some cases, face masks may comprise exhalation valves. Filtering masks typically contain filtering media that can lock up potentially hazardous particulate matter.

### SUMMARY

In an embodiment, a filtering mask may comprise at least one filter media layer configured to filter particulate matter to produce breathable air; and at least one anti-counterfeit layer attached to the at least one filter media layer, configured to identify the filtering mask as a legitimate filter and distinguish the filtering mask from counterfeit masks, wherein the anti-counterfeit layer comprises at least one logo incorporated into at least one surface of the anti-counterfeit layer.

In an embodiment, a method of manufacturing a filtering mask may comprise extruding a filtering material from a source of the filtering material; melt-blowing the extruded filtering material to form a plurality of fibers; collecting the melt-blown fibers onto an outer surface of a lathe, wherein the outer surface of the lathe comprises a logo pattern; forming a fiber material about the logo pattern on the outer surface of the lathe via the collected melt-blown fibers; removing the formed fiber material to create an anti-counterfeit layer for use in the filtering mask, wherein at least one surface of the anti-counterfeit layer comprises the logo pattern within the fiber material; and assembling the anti-counterfeit layer within the filtering mask.

In an embodiment, a method of identifying a legitimate filtering mask may comprise attaching at least one layer of filter media to a layer of anti-counterfeit material, wherein the anti-counterfeit material comprises a logo pattern; forming the filtering mask using the attached filter media and anti-counterfeit material; and distinguishing the filtering mask from counterfeit filtering mask(s) by observing the anti-counterfeit material.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIGS. 1A-1B illustrate side views of a filtering mask according to an embodiment of the disclosure.

FIG. 2 illustrates a cross-sectional view of a filtering mask according to an embodiment of the disclosure.

FIG. 3 illustrates a detailed view of an anti-counterfeit layer according to an embodiment of the disclosure.

FIG. 4 illustrates a manufacturing process for at least a portion of a filtering mask according to an embodiment of the disclosure.

FIG. 5 illustrates a lathe for use in the manufacturing process of FIG. 4 according to an embodiment of the disclosure.

FIGS. 6A-6B illustrate a method for identifying a legitimate filtering mask according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Embodiments of the disclosure include systems and methods for identifying a legitimate/authentic air purifying filter and/or mask (e.g. from a specific manufacturer/company) and preventing counterfeit or fake products. Typical filtering masks use a particulate filtering material to provide breathable air to a user. These filtering masks are important personal protection equipment for workers who require respiratory protection in many industries, such as mining, ship building and heavy machinery. These filtering masks may also be worn by regular consumers who live in highly polluted areas.

Typical filtering masks may be certified to filter a certain type and/or amount of harmful substances. Counterfeit masks may exist that are produced by other (e.g. illegitimate and/or unauthorized) companies, where the masks may be marketed identically to the legitimate masks, or in some cases the counterfeit masks may impersonate the legitimate masks. The counterfeit masks may mimic legitimate filtering masks without providing the same level of protection. If a user attempts to use a counterfeit filtering mask that is not designed to filter harmful substances, the mask may not provide adequate protection to the user. This may cause a user to be exposed to dangerous particulate matter, even though the user may believe he or she is protected by using the filtering mask/air purifying mask.

Embodiments of the disclosure include systems and methods for preventing the use of counterfeit filtering masks. To identify a legitimate mask, the mask may comprise an anti-counterfeit element incorporated into the mask material. In some cases, the anti-counterfeit element may comprise one or more features incorporated into one layer of filtering material of the mask.

As the market for particulate filtering masks grows, counterfeit masks may become prevalent. This may impact the business of legitimate companies; may endanger workers who use the counterfeit masks; and may damage the reputation of the legitimate companies if users purchase counterfeit masks believing they are legitimate masks. Utilizing an anti-counterfeit element (e.g., such as specific anti-counterfeit layers) as disclosed herein, may allow users to identify legitimate masks and may protect the companies involved.

In some cases, the anti-counterfeit element may allow a user (or an individual person) to identify that the mask is a legitimate particulate filtering mask and not a counterfeit. For example, a person may purchase a legitimate particulate filtering mask, and before wearing/using it, he/she may verify that the mask is not a fake by observing the anti-counterfeit element (e.g., by following instructions provided by the legitimate manufacturer/company). Additionally, the anti-counterfeit element may prevent/mitigate liability for a legitimate company in the event that a person uses a fake particulate filtering mask. As an example, a person may use a mask that is a fake or counterfeit mask, the person may sue the legitimate company when the mask does not protect them, but the company may avoid/mitigate liability due to the anti-counterfeit element that is in legitimate masks, but not in the fake/counterfeit masks. In such instances, the legitimate manufacturer/company may keep some or all of its specific anti-counterfeit technology secret, and only selectively disclose, as needed, to protect itself by demonstrating that a failed mask is fake/illegitimate (e.g. from some other source, and therefore not the legal responsibility of the legitimate manufacturer/company).

Embodiments of the disclosure include an anti-counterfeit technology that comprises a “knurled” logo incorporated into the surface of at least one layer of filtering material within the mask, where the logo identifies the manufacturer of the mask. “Knurled” may describe the method for applying the logo to the filtering media. The process of knurling may comprise the use of a cylindrical lathe with a particular pattern on the outer surface of the lathe, where the pattern is applied to the material from the lathe. However, while typical knurling methods may involve pressing the lathe into the material to apply the pattern, disclosed embodiments may comprise a different use of the lathe to apply the pattern to the material (as described further herein).

In the embodiments disclosed herein, the anti-counterfeit layer may comprise the knurled logo on at least one surface of the anti-counterfeit layer. Additionally, in some embodiments, the anti-counterfeit layer may comprise an interior layer of the mask that may not be visible from the outside of the mask when the mask is fully assembled. When the anti-counterfeit layer is an interior layer of the mask, a user may at least partially disassemble the mask to view the anti-counterfeit layer within the material of the mask.

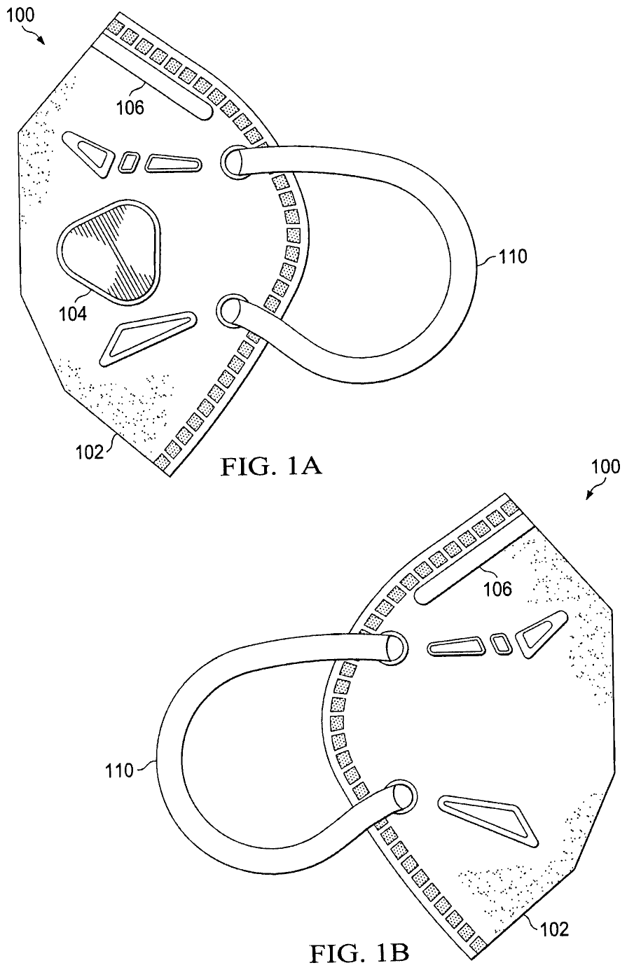

Referring now to FIGS. 1A-1B, an exemplary embodiment of a mask 100 is shown. FIG. 1A illustrates a first side of the mask 100, while FIG. 1B illustrates a second, opposite, side of the mask 100. The mask 100 may comprise at least one layer of a filter material or media 102 shaped to fit around a user's face. In some embodiments, the mask 100 may comprise a plurality of layers of filter media 102. The mask 100 may comprise an exhalation valve 104 configured to allow exhaled air and/or moisture to exit the mask 100 while the user is wearing the mask 100, while also preventing airflow into the mask 100 via the exhalation valve 104 (where airflow into the mask 100 may only be allowed through the filter media 102). The mask 100 may comprise a nose clip 106 configured to adjust to fit around a portion of a user's nose. The mask 100 may be configured to filter one or more harmful substances from the air from entering a user's nose and/or mouth.

The mask 100 may comprise one or more straps 110, which may comprise any of head straps, ear straps, neck straps, and the like. The straps 110 may be configured to hold the mask 100 against the user's face. In some embodiments, the straps 110 may be configured to hold the mask 100 against the user's face with enough force and/or tension to at least partially seal the mask 100 with the user's face.

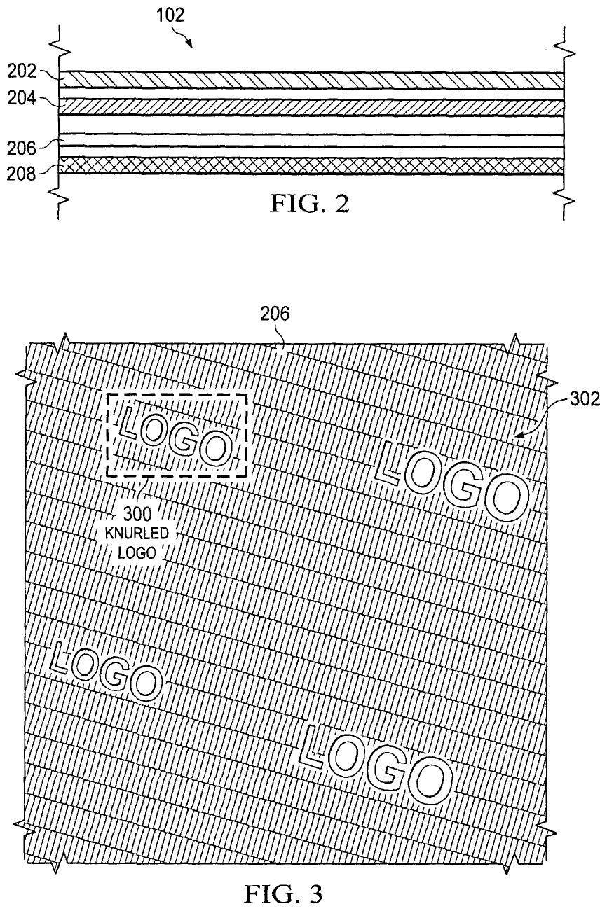

In the embodiments described herein, the filter media 102 of the mask 100 may comprise a plurality of layers. Referring to FIG. 2, a cross-sectional view of the filter media 102 is shown. The filter media 102 may comprise an inner layer 202 configured to form the inner surface of the mask 100 and to contact the user's face. The filter media 102 may comprise an outer layer 208 configured to form the outer surface of the mask 100 (furthest from the user's face). In some embodiments, the filter media 102 may comprise an optional interior layer 204 of additional filtering material (i.e., located between the inner layer 202 and the outer layer 208).

In the embodiments disclosed herein, the filter media 102 may comprise an anti-counterfeit layer 206. The anti-counterfeit layer 206 may be located between the inner layer 202 and the outer layer 208. The anti-counterfeit layer 206 may be located above or below any other interior layer(s) 204, depending on the embodiment.

FIG. 3 illustrates a detailed view of the anti-counterfeit layer 206 comprising a knurled logo 300 incorporated into at least one surface of the anti-counterfeit layer 206. The knurled logo 300 may be incorporated as a pattern on the surface of the anti-counterfeit layer 206. In some embodiments, the logo 300 may comprise a size of at least 2 mm by 2 mm. In some embodiments, the logo 300 may comprise a size of at least 5 mm by 5 mm. In some embodiments, the logo 300 may comprise a size of approximately 55 millimeters (mm) long and approximately 10 mm tall. In some embodiments, the distance between two logos 300 may be between approximately 20 mm and 50 mm. In some embodiments, the anti-counterfeit layer 206 may comprise additional ridges and or pattern 302 within the material between the logos 300. In some embodiments, the pattern 302 may comprise a plurality of oblique lines, where the length of each line is between approximately 2 to 6 mm.

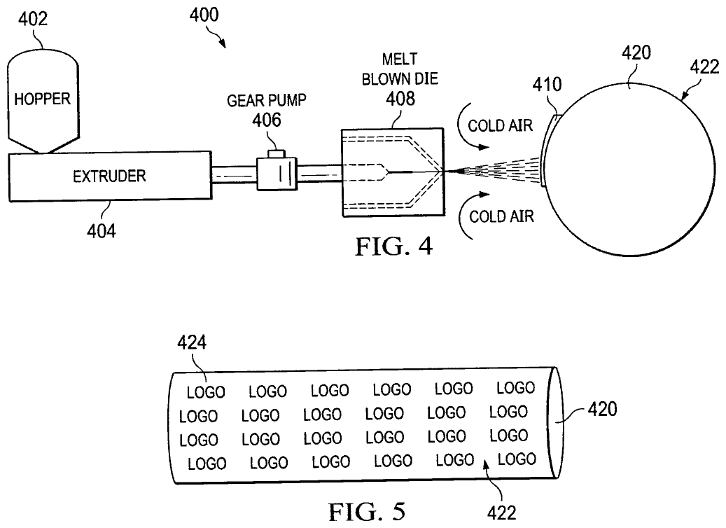

FIG. 4 illustrates an exemplary method for forming the anti-counterfeit layer 206 using a lathe 420 as a fiber collector. The process 400 may comprise extruding a material 404 from a hopper 402 of the material, wherein the extruded material 404 may be moved through the process 400 via a gear pump 406 (possibly using a conveyer or other similar mechanism). The hopper 402 may comprise material that will eventually form a filtration material. The extruded material 404 may be melt-blown by a melt-blowing die 408 and sprayed toward the lathe 420 to form a fiber material 410 on the surface of the lathe 420 of the melt-blown material. In some embodiments, the lathe 420 may be rotated while the fiber material 410 is formed onto the outer surface 422 of the lathe, thereby creating a sheet of fiber material 410 about the outer surface 422. This sheet of fiber material 410 may eventually form the anti-counterfeit layer 206 of the mask 100 (as described above).

In the embodiment shown in FIG. 4, the outer surface 422 of the lathe 420 may comprise a pattern of logos incorporated into the outer surface 422. In some embodiments, the pattern of logos may protrude from the outer surface 422 of the lathe 420, such that when the fiber material 410 is formed onto the outer surface 422, it may be formed around the protruding logo, leaving an imprint of the logo in the finished material (as shown in FIG. 3) when the sheet of fiber material is removed from the lathe 420. In some embodiments, the lathe 420 may not press into or apply any pressure to the fiber material 410 formed onto the outer surface 422. This may prevent any damage to or compromise of the filtering properties of the fiber material 410.

FIG. 5 illustrates a detailed view of the lathe 420, showing the logo pattern 424 on the outer surface 422 of the lathe 420. The “logo” may comprise any text and/or image that may identify the manufacturer of the mask 100. The logo pattern 424 may comprise approximately 800-1000 individual logos on the outer surface 422 of the lathe 420. The logo pattern 424 may be created by precision machining of the outer surface 422 of the lathe 420, where each logo may be identical in shape and depth (i.e., distance protruding from the outer surface 422).

The manufacturing process of the anti-counterfeit material may be difficult for a counterfeiter to copy. A counterfeiter may not have the technology to create a precise logo within the filter material of the mask. Additionally, any other patterned texture on the anti-counterfeit material/layer may help distinguish the legitimate mask from counterfeit masks.

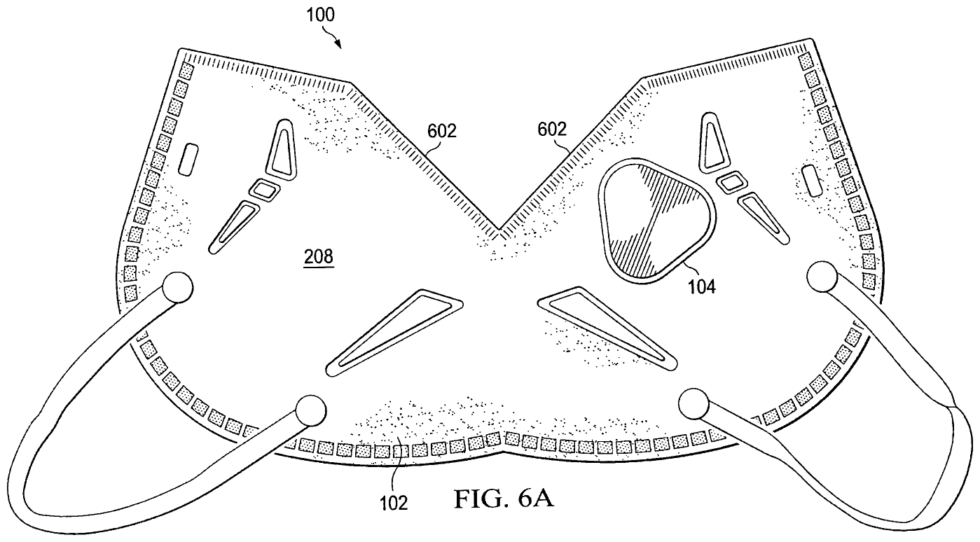

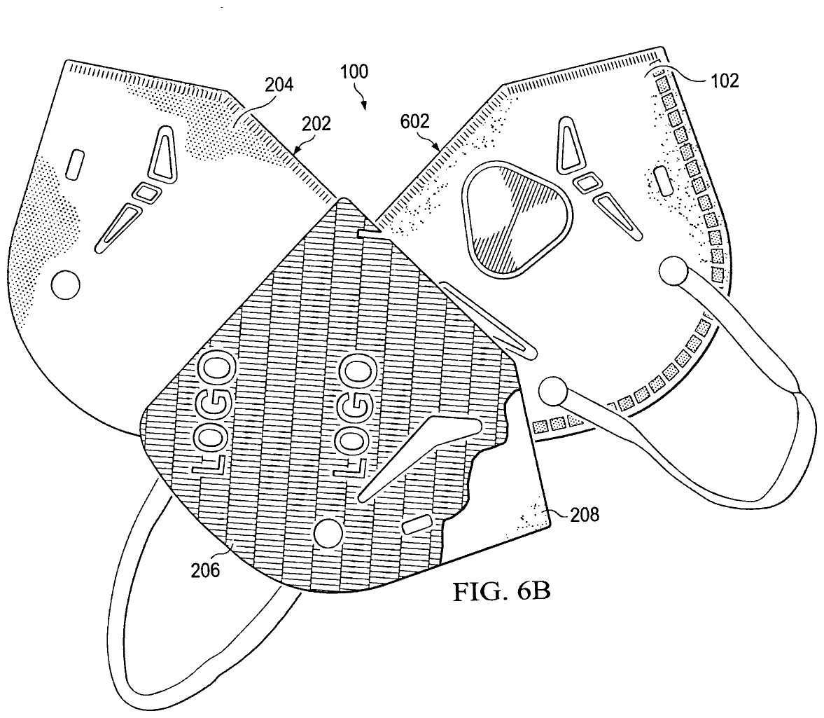

FIGS. 6A-6B illustrate a method for how a customer may identify a legitimate mask 100 by viewing the anti-counterfeit layer. As an exemplary use case, a customer may receive a large supply of masks 100 from a vendor. Before the masks are used by anyone, the customer may wish to verify that the masks are legitimate. To do so, the customer may deconstruct one of the masks 100 using the method shown in FIGS. 6A-6B.

In FIG. 6A, the filter material 102 of the mask 100 may be torn along a middle seam 602 to lay the mask 100 flat. This step may make it easier for the user to access the anti-counterfeit layer 206.

In FIG. 6B, at least the outer layer 208 of the filter material 102 may be torn away from the rest of the mask 100. In some embodiments, by tearing away the outer layer 208, the surface of the anti-counterfeit layer 206 that comprises the logos 300 may be exposed to the user (without having to tear away the anti-counterfeit layer as well). In an alternative embodiment, the anti-counterfeit layer 206 may be torn away from the rest of the mask 100 to expose the surface of the anti-counterfeit layer 206 that comprises the logos 300. In some embodiments, the anti-counterfeit layer 206 may be located directly below the outer layer 208, while in other embodiments the mask 100 may comprise additional inner layers. Then, after the customer has verified that the large supply of masks 100 is legitimate, they may continue with use and/or distribution of the masks 100.

Having described various devices and methods herein, exemplary embodiments or aspects can include, but are not limited to:

In a first embodiment, a filtering mask may comprise at least one filter media layer configured to filter particulate matter to produce breathable air; and at least one anti-counterfeit layer attached to the at least one filter media layer, configured to identify the filtering mask as a legitimate filter and distinguish the filtering mask from counterfeit masks, wherein the anti-counterfeit layer comprises at least one logo incorporated into at least one surface of the anti-counterfeit layer.

A second embodiment can include the filtering mask of the first embodiment, wherein the at least one filter media layer comprises a plurality of filter media layers, and wherein each of the filter media layers is configured to filter particulate matter from air flow through the filter.

A third embodiment can include the filtering mask of the first or second embodiment, wherein the at least one filter media layer comprises an outer layer, and wherein the anti-counterfeit layer is located proximate to the outer layer.

A fourth embodiment can include the filtering mask of the third embodiment, wherein the at least one filter media layer comprises an inner layer forming the inner surface of the mask, and wherein the anti-counterfeit layer is located between the outer layer and the inner layer.

A fifth embodiment can include the filtering mask of any of the first through fourth embodiments, wherein the anti-counterfeit layer comprises a pattern of a plurality of logos that are formed into the material of the anti-counterfeit layer.

A sixth embodiment can include the filtering mask of any of the first through fifth embodiments, wherein the at least one logo is incorporated into the at least one surface of the anti-counterfeit layer by forming the anti-counterfeit layer onto a lathe comprising the at least one logo protruding from the surface of the lathe.

A seventh embodiment can include the filtering mask of any of the first through sixth embodiments, wherein the at least one logo is incorporated into the anti-counterfeit layer without applying any pressure to the material of the anti-counterfeit layer.

An eighth embodiment can include the filtering mask of any of the first through seventh embodiments, wherein the anti-counterfeit layer comprises a filtering material.

A ninth embodiment can include the filtering mask of any of the first through eighth embodiments, wherein the at least one logo comprises text and/or image(s) identifying the manufacturer of the mask.

In a tenth embodiment, a method of manufacturing a filtering mask may comprise extruding a filtering material from a source of the filtering material; melt-blowing the extruded filtering material to form a plurality of fibers; collecting the melt-blown fibers onto an outer surface of a lathe, wherein the outer surface of the lathe comprises a logo pattern; forming a fiber material about the logo pattern on the outer surface of the lathe via the collected melt-blown fibers; removing the formed fiber material to create an anti-counterfeit layer for use in the filtering mask, wherein at least one surface of the anti-counterfeit layer comprises the logo pattern within the fiber material; and assembling the anti-counterfeit layer within the filtering mask.

An eleventh embodiment can include the method of the tenth embodiment, further comprising forming an outer layer of the filtering material; forming an inner layer of the filtering material; and assembling the anti-counterfeit layer between the outer layer and the inner layer.

A twelfth embodiment can include the method of the tenth or eleventh embodiment, further comprising machining the outer surface of the lathe to create the logo pattern, wherein the logo pattern protrudes from the outer surface of the lathe.

A thirteenth embodiment can include the method of any of the tenth through twelfth embodiments, wherein melt-blowing the extruded filtering material comprises blowing the fibers using cold air toward the outer surface of the lathe.

A fourteenth embodiment can include the method of any of the tenth through thirteenth embodiments, wherein the logo pattern comprises a plurality of the same logo in a repeated pattern.

A fifteenth embodiment can include the method of any of the tenth through fourteenth embodiments, further comprising rotating the outer surface of the lathe while collecting the melt-blown fibers onto the outer surface of the lathe, wherein the lathe comprises a cylindrical shape.

In a sixteenth embodiment, a method of identifying a legitimate filtering mask may comprise attaching at least one layer of filter media to a layer of anti-counterfeit material, wherein the anti-counterfeit material comprises a logo pattern; forming the filtering mask using the attached filter media and anti-counterfeit material; and distinguishing the filtering mask from counterfeit filtering mask(s) by observing the anti-counterfeit material.

A seventeenth embodiment can include the method of the sixteenth embodiment, wherein observing the anti-counterfeit material comprises observing the logo pattern formed into the anti-counterfeit material.

An eighteenth embodiment can include the method of the sixteenth or seventeenth embodiment, further comprising assembling the layer anti-counterfeit material between an outer layer and an inner layer of the filtering mask.

A nineteenth embodiment can include the method of the eighteenth embodiment, wherein distinguishing the filtering mask from counterfeit filtering mask(s) by observing the anti-counterfeit material comprises exposing the anti-counterfeit material layer by removing at least one of the outer layer and/or the inner layer.

A twentieth embodiment can include the method of the eighteenth or nineteenth embodiments, wherein the anti-counterfeit material is not visible to a user unless the filtering mask is at least partially disassembled.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A filtering mask comprising:
at least one filter media layer configured to filter particulate matter to produce breathable air and comprising an outer layer and an inner layer, the inner layer forming an inner surface of the filtering mask; and
at least one anti-counterfeit layer attached to the at least one filter media layer and configured to identify the filtering mask as a legitimate filter and distinguish the filtering mask from counterfeit masks, wherein the at least one anti-counterfeit layer comprises at least one logo incorporated into at least one surface of the at least one anti-counterfeit layer, wherein the at least one anti-counterfeit layer is located between the inner layer and the outer layer.

2. The filtering mask of claim 1, wherein the at least one filter media layer comprises a plurality of filter media layers, and wherein each of the plurality of filter media layers is configured to filter particulate matter from air flow through the filter.

3. (canceled)

4. (canceled)

5. The filtering mask of claim 1, wherein the at least one anti-counterfeit layer comprises a pattern of a plurality of logos that are formed into material of the at least one anti-counterfeit layer.

6. The filtering mask of claim 1, wherein the at least one logo is incorporated into the at least one surface of the at least one anti-counterfeit layer by forming the at least one anti-counterfeit layer onto a lathe comprising the at least one logo protruding from the at least one surface of the lathe.

7. The filtering mask of claim 1, wherein the at least one logo is incorporated into the at least one anti-counterfeit layer without applying any pressure to material of the at least one anti-counterfeit layer.

8. The filtering mask of claim 1, wherein the at least one anti-counterfeit layer comprises a filtering material.

9. The filtering mask of claim 1, wherein the at least one logo comprises text and/or an image identifying a manufacturer of the filtering mask.

10. A method of manufacturing a filtering mask, the method comprising:
extruding a filtering material from a source of the filtering material;
melt-blowing the extruded filtering material to form a plurality of fibers;
collecting the melt-blown fibers onto an outer surface of a lathe, wherein the outer surface of the lathe comprises a logo pattern;
forming a fiber material about the logo pattern on the outer surface of the lathe via the collected melt-blown fibers;
removing the formed fiber material to create an anti-counterfeit layer for use in the filtering mask, wherein at least one surface of the anti-counterfeit layer comprises the logo pattern within the fiber material; and
assembling the anti-counterfeit layer within the filtering mask.

11. The method of claim 10, further comprising:
forming an outer layer of the filtering material;
forming an inner layer of the filtering material; and
assembling the anti-counterfeit layer between the outer layer and the inner layer.

12. The method of claim 10, further comprising machining the outer surface of the lathe to create the logo pattern, wherein the logo pattern protrudes from the outer surface of the lathe.

13. The method of claim 10, wherein melt-blowing the extruded filtering material comprises blowing the plurality of fibers using cold air toward the outer surface of the lathe.

14. The method of claim 10, wherein the logo pattern comprises a plurality of the same logo in a repeated pattern.

15. The method of claim 10, further comprising rotating the outer surface of the lathe while collecting the melt-blown fibers onto the outer surface of the lathe, wherein the lathe comprises a cylindrical shape.

16. The filtering mask of claim 1, wherein the outer layer is removable from the filtering mask to expose the at least one anti-counterfeit layer.

17. A method of identifying a filtering mask, the method comprising:
forming the filtering mask by attaching an anti-counterfeit layer to at least one filter media layer, wherein the at least one filter media layer comprises an outer layer and an inner layer, wherein the inner layer forms an inner surface of the filtering mask, and wherein the anti-counterfeit layer is located between the outer layer and the inner layer, and wherein the anti-counterfeit layer comprises a logo pattern; and
distinguishing the filtering mask from a counterfeit filtering mask by identifying the anti-counterfeit layer.

18. The method of claim 17, wherein the logo pattern is formed on at least one surface of the anti-counterfeit layer.

19. The method of claim 18, wherein identifying the anti-counterfeit layer comprises identifying the logo pattern formed on the at least one surface of the anti-counterfeit layer.

20. The method of claim 17, wherein the outer layer is removable from the filtering mask, wherein the inner layer is removable from the filtering mask.

21. The method of claim 20, wherein distinguishing the filtering mask from the counterfeit filtering mask by identifying the anti-counterfeit layer comprises exposing anti-counterfeit layer by removing at least one of the outer layer or the inner layer.

22. The method of claim 17, wherein distinguishing the filtering mask from the counterfeit filtering mask further comprises at least partially disassembling the filtering mask.
